(19) United States
(12) Patent Application Publication
(10) Pub. No.: US 2009/0040456 A1
(43) Pub. Date: Feb. 12, 2009

(54) Eyeglasses Structure

(76) Inventor: Te-Yao Yang, Cingshuei Township (TW)

Correspondence Address: Troxell Law Office Pllc, Suite 1404, 5205 Leesburg Pike, Falls Church, VA, 22041, US

(21) Appl. No.: 11/882,780

(22) Filed: Aug. 6, 2007

(51) Int. Cl. G02C 5/00

(52) U.S. Cl. 351/136

(57) ABSTRACT

An eyeglasses structure, structured from eyeglasses and a soft portion, wherein the eyeglasses include a pair of lenses respectively embedded in two frames, a bridge connected between the two frames and hinges respectively located on outer sides of the two frames. The two hinges are respectively outwardly pin connected to temples. A soft pad portion includes a pair of frame portions having the same shape as the eyeglasses frames, a bridge connected between the two frame portions and a pair of nose pads integratedly connected to the frame portions of two sides of the bridge. The soft pad portion is fabricated from flexible soft material and connected to inner sides of the eyeglasses frames using a processing method, thereby constructing the improved eyeglasses structure provided with a safety protective function.

### BACKGROUND OF THE INVENTION

(a) Field of the Invention

The present invention relates to a an improved eyeglasses structure, and more particularly to the design wherein a soft pad portion fabricated from flexible soft material is connected to inner sides of eyeglasses frames using a processing method to construct an improved eyeglasses structure provided with a safety protective function.

(b) Description of the Prior Art

The majority of eyeglasses of prior art use plastic type sheet material of high hardness to serve as the basic material for the frame portions and the temples. Hence, in actual use, should an accident occur whereby an external force inadvertently impacts with the eyeglasses, especially for general, lively and active young people, then the hard frame easily results in apprehension over safety of important areas of the face of the user, including the eyes, and the like.

Prior art eyeglasses also include some relatively safe design measures, wherein such eyeglasses are fabricated from flexible material which enable frame portions of the eyeglasses and temples to recover their original form after being twisted and distorted. However, should an accident occur whereby an external force inadvertently impacts with the eyeglasses, although the aforementioned prior art eyeglasses may guarantee that the eyeglasses do not break or become damaged, but such an impact could still cause injury to the face of the user.

### SUMMARY OF THE INVENTION

In light of the aforementioned shortcomings and distress of prior art, and with the intention to resolve such, the present invention provides an improved eyeglasses structure.

Hence, a primary objective of the present invention is to provide an improved eyeglasses structure designed with a soft pad portion fabricated from flexible soft material that is connected to inner sides of eyeglasses frames using a processing method to construct an improved eyeglasses structure provided with safe and protective functionality.

In order to achieve the aforementioned objective, the present invention adopts the following technical proposal.

The improved eyeglasses structure of the present invention is primarily structured to comprise eyeglasses and a soft pad portion.

The eyeglasses comprise a pair of lenses respectively embedded within two frames, a bridge is connected between the two frames, and hinges are respectively located on outer sides of the two frames. The two hinges respectively outwardly pin connect to temples.

The soft pad portion comprises a pair of frame portions having the same shape as the eyeglasses frames and a bridge connected between the two frame portions. Moreover, a pair of nose pads are integratedly connected to the frame portions of two sides of the bridge.

The aforementioned soft pad portion is fabricated from flexible soft material, and is connected to the inner sides of the eyeglasses frames using a processing method to form a soft and protective device between the eyeglasses and the face of the user. Should an accident occur whereby an external force inadvertently impacts with the eyeglasses, then the soft pad portion ensures that the eyeglasses do not break or become damaged. Moreover, the flexible soft pad portion simultaneously protects the face of the user from injury.

It is preferred that the aforementioned eyeglasses use flexible material, which is able to quickly recover its original form after being twisted and distorted, to fabricate the eyeglasses frames and the temples.

Aftermentioned different embodiments of the soft pad portions of the present invention use different processing methods to connect to the inner sides of the eyeglasses frames, including adhesive, high frequency or embedding methods.

In the aftermentioned different embodiments of the present invention, a second soft pad portion is disposed on an outer side of the eyeglasses, thereby increasing safety of the eyeglasses.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows an elevational view depicting an external appearance of an improved eyeglasses structure of the present invention.

FIG. 2 shows an exploded view depicting components of the improved eyeglasses structure of the present invention, wherein two temples are separated from the eyeglasses, and a first soft pad portion is disassembled from a frame.

FIG. 3 shows a top view of frames of the improved eyeglasses structure of the present invention.

FIG. 4 shows an exploded view of FIG. 3 of the improved eyeglasses structure of the present invention.

FIG. 5 shows a top view depicting a second embodiment of the frames of the improved eyeglasses structure of the present invention.

FIG. 6 shows a top view depicting a third embodiment of the frames of the improved eyeglasses structure of the present invention.

### DETAILED DESCRIPTION OF THE PREFERRED EMBODIMENTS

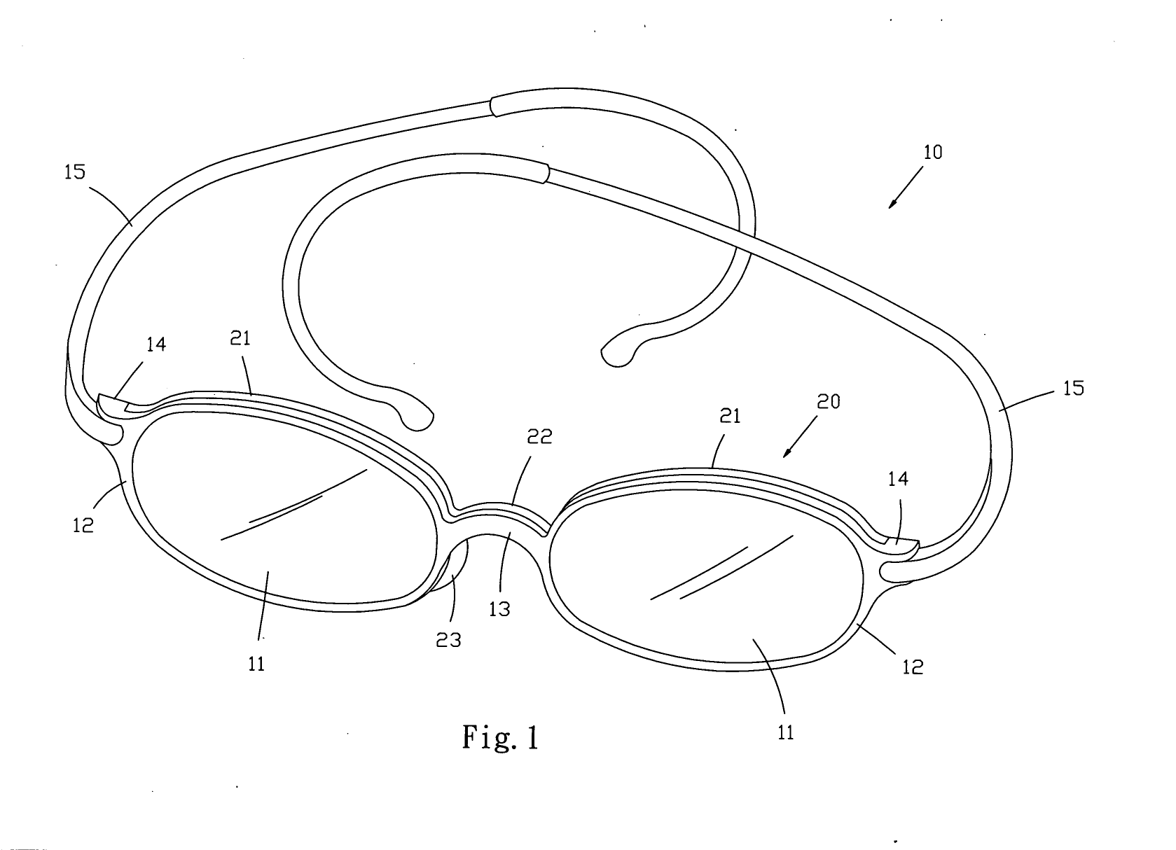

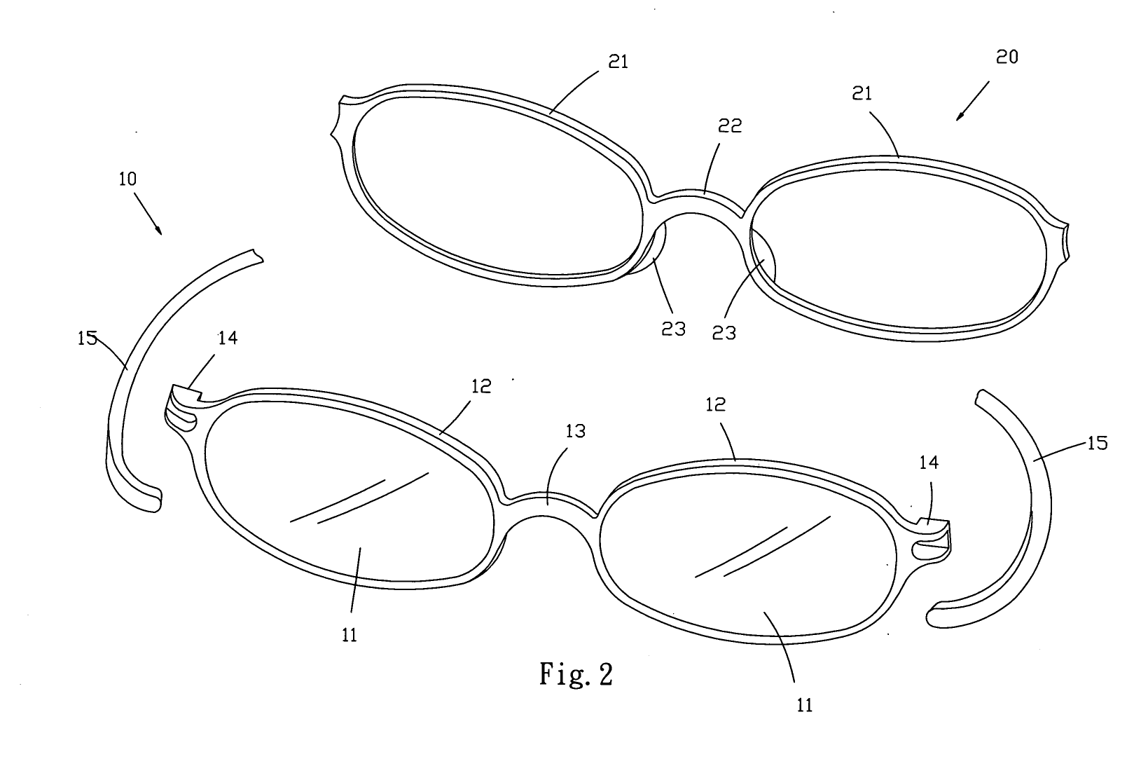

Referring to FIG. 1 and FIG. 2, which show an improved eyeglasses structure of the present invention, primarily structured to comprise the eyeglasses 10 and the first soft pad portion 20.

As depicted in the drawings, the eyeglasses 10 comprise a pair of lenses 11 respectively embedded in the frames 12, a first bridge 13 connected between the two frames 12 and hingess 14 respectively located on outer sides of the two frames 12. The two hinges 14 respectively outwardly pin connect to temples 15.

Referring to FIG. 2, which shows the first soft pad portion 20 comprising a pair of first frame portions 21 having the same shape as the eyeglasses frames 12, a second bridge 22 connected between the two first frame portions 21, and a pair of first nose pads 23 integratedly connected to inner sides of the first frame portions 21 of two sides of the second bridge 22.

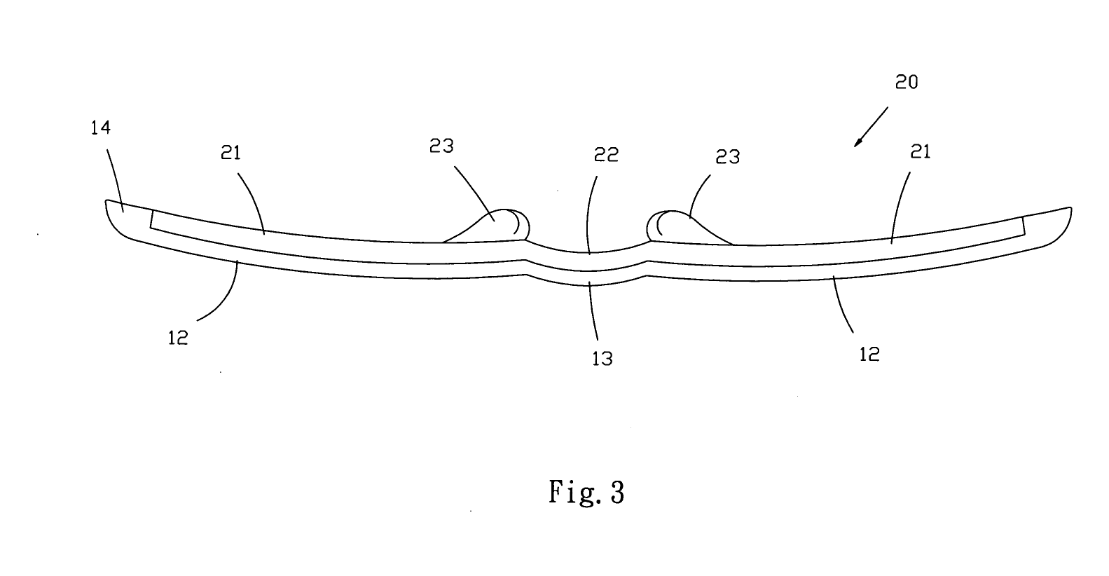

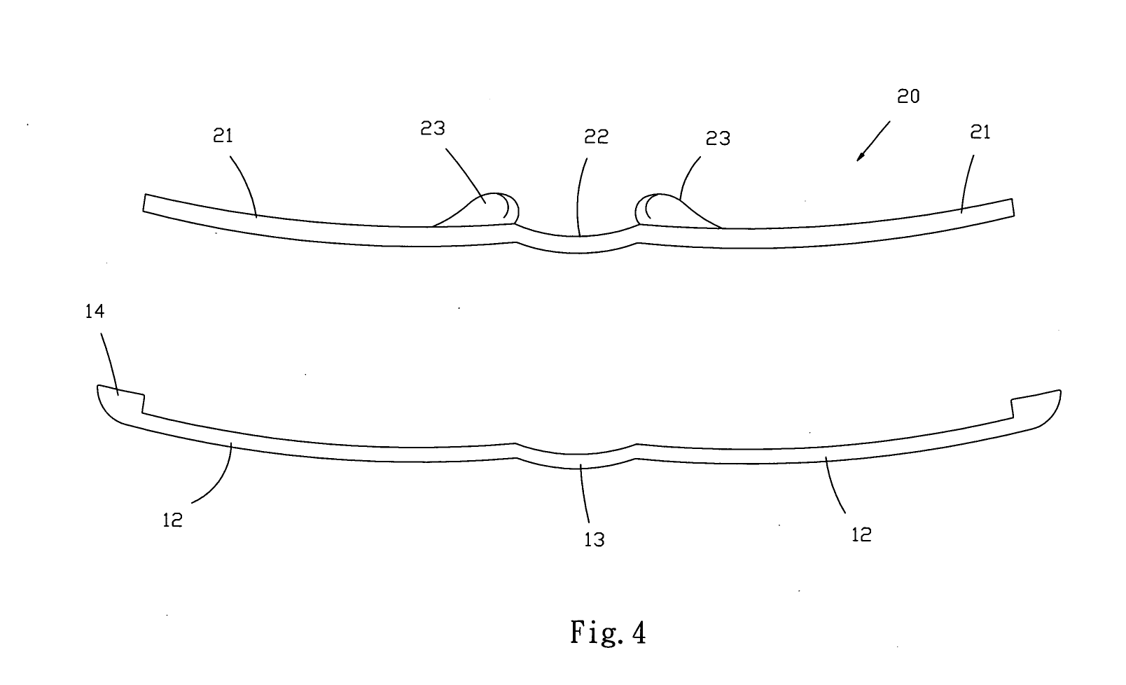

Referring to FIG. 3 and FIG. 4, the aforementioned first soft pad portion 20 is fabricated from flexible soft material and connected to inner sides of the eyeglasses frames 12 using a processing method to form a soft, safe protective device between the eyeglasses 10 and the face of a user. Should an accident occur whereby an external force inadvertently impacts with the eyeglasses 10, then the first soft pad portion 20 ensures the eyeglasses 10 do not break or become damaged, moreover, the flexible first soft pad portion 20 simultaneously protects the face of the user from injury.

Different processing methods can be used to connect the aforementioned first soft pad portion 20 to the inner sides of the eyeglasses frames 12, including adhesive, high frequency, or embedding methods.

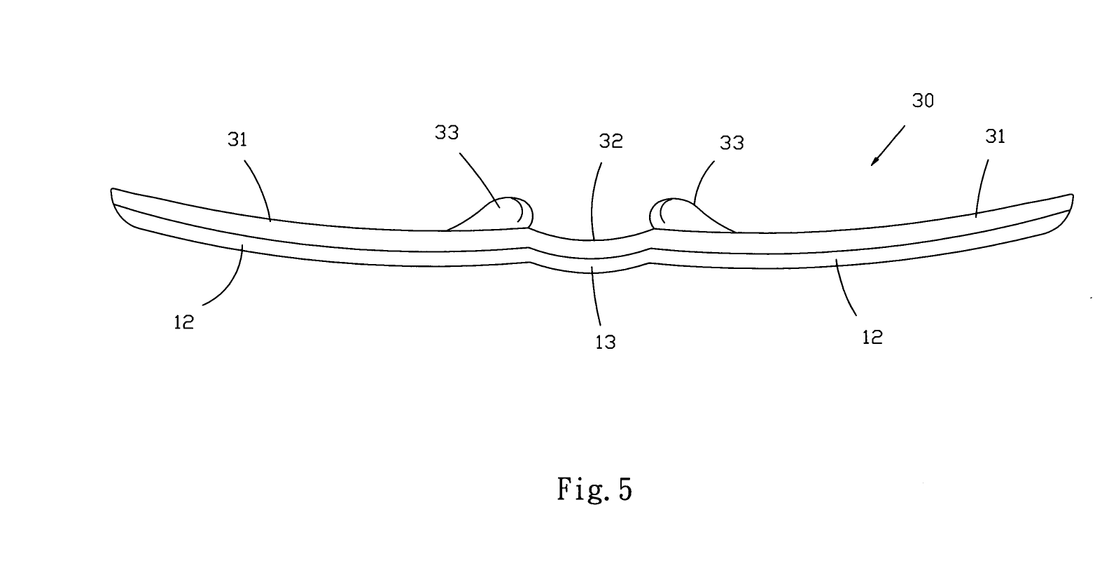

FIG. 5 shows a top view depicting a second embodiment of the frames 12 of the improved eyeglasses structure of the present invention.

Referring to FIG. 5, which shows the second embodiment of the improved eyeglasses structure of the present invention structured to comprise a second soft pad portion 30 connected to the inner sides of the frames 12 of the eyeglasses 10 using an adhesive or high frequency processing method. The second soft pad portion 30 comprises a pair of second frame portions 31 having the same shape as the eyeglasses frames 12, a third bridge 32 connected between the two second frame portions 31, and a pair of second nose pads 33, integratedly connected to inner sides of the second frame portions 31 of two sides of the second bridge 32. Accordingly, the second soft pad portion 30 forms a soft, safe protective device between the eyeglasses 10 and the face of a user.

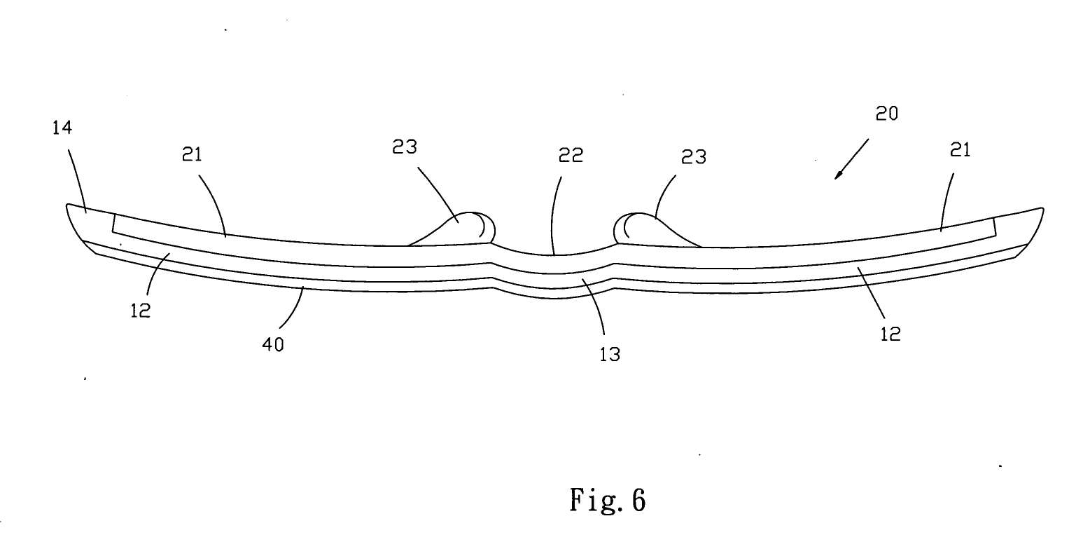

FIG. 6 shows a top view depicting a third embodiment of the frames 12 of the improved eyeglasses structure of the present invention.

Referring to FIG. 6, which shows the third embodiment of the improved eyeglasses structure of the present invention comprising the first soft pad portion 20 connected to the inner sides of the frames 12 using an embedding process in conjunction with adhesive, and a third soft pad portion 40 connected to outer sides of the frames 12 using an adhesive or a high frequency process. Accordingly, the first soft pad portion 20 forms a soft, safe protective device between the eyeglasses 10 and the face of a user, and the third soft pad portion 40 form a soft, safe, protective device on the outer side of the eyeglasses 10.

Furthermore, another characteristic of the present invention includes fabricating the soft pad portions and the second soft pad portion 20 from various soft material of identical or different color to that of the frames 12, thereby varying the overall outward aesthetic visual effectiveness of the eyeglasses to meet with different consumer requirements.

According to the aforementioned description of the present invention, in short, should an accident occur whereby an external force inadvertently impacts with the eyeglasses 10, then the design of the soft pad portions fabricated from flexible soft material ensure the eyeglasses 10 do not break or become damaged. Moreover, the flexible soft pad portions simultaneously protect the face of a user from injury, thereby achieving the aforementioned objectives.

In conclusion, the present invention clearly achieves the anticipated functions and objectives, and moreover describes in detail the prior art.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An eyeglasses structure, comprising:
eyeglasses having a pair of lenses respectively embedded in two frames, a bridge is connected between the two frames, and hinges are respectively located on outer sides of the two frames, the two hinges are respectively outwardly pin connected to temples; and
a soft pad portion comprising a pair of frame portions having the same shape as the eyeglasses frames, a bridge is connected between the two frame portions, and a pair of nose pads integratedly connected to inner sides of the frame portions of two sides of the bridge; the soft pad portion is fabricated from flexible soft material and connected to inner sides of the eyeglasses frames using a processing method to form a soft, safe protective device between the eyeglasses and the face of a user.

2. The eyeglasses structure according to claim 1, comprising the soft pad portion connected to the inner sides of the frames and a second soft pad portion connected to outer sides of the frames, accordingly, the soft pad portion forms a soft, safe protective device between the eyeglasses and the face of a user, and the second soft pad portion forms a soft, safe, protective device on the outer side of the eyeglasses.

3. The eyeglasses structure according to claim 1, wherein the soft pad portion and the second soft pad portion are fabricated using various soft material of identical or different color to that of the frames.

4. The eyeglasses structure according to claim 2, wherein the soft pad portion and the second soft pad portion are fabricated using various soft material of identical or different color to that of the frames.
